(19) United States
(12) Patent Application Publication
(10) Pub. No.: US 2014/0310010 A1
(43) Pub. Date: Oct. 16, 2014

(54) APPARATUS FOR ENCODING AND APPARATUS FOR DECODING SUPPORTING SCALABLE MULTICHANNEL AUDIO SIGNAL, AND METHOD FOR APPARATUSES PERFORMING SAME

(71) Applicant: Electronics and Telecommunications Research Institute, Daejeon (KR)

(72) Inventors: Jeong ll Seo, Daejeon (KR); Seung Kwon Beack, Daejeon (KR); Kyeong Ok Kang, Daejeon (KR); Tae Jin Lee, Daejeon (KR); Yong Ju Lee, Daejeon (KR); Jae Hyoun Yoo, Daejeon (KR); Keun Woo Choi, Daejeon (KR); Jin Woong Kim, Daejeon (KR)

(21) Appl. No.: 14/358,104

(22) PCT Filed: Nov. 13, 2012
(86) PCT No.: PCT/KR2012/009543

§ 371 Date: May 14, 2014

(30) Foreign Application Priority Data
Nov. 14, 2011 (KR) 10-2011-0118102
Nov. 12, 2012 (KR) 10-2012-0127499

(51) Int. Cl. G10L 19/008

(52) U.S. Cl. CPC G10L 19/008
USPC 704/500

(57) ABSTRACT

An encoding apparatus and a decoding apparatus supporting a scalable multichannel audio signal, and methods performed by the apparatuses art provided. When compressing and decompressing a multichannel audio signal to compress and reproduce high quality 3-dimensional (3D) audio, the apparatuses and the methods in integrated form of (1) a sound quality scalability function for providing various qualities of audio adaptively to a transmission environment, terminal performance, and a listening environment (2) a channel scalability function for providing multichannel signals of various formats adaptively to the transmission environment, the terminal performance, and a reproduction environment of a terminal, such as speaker arrangement, and (3) an object scalability function for independently controlling a particular audio object to maximize a 3D sound field effect.

### TECHNICAL FIELD

The present invention relates to an encoding apparatus and a decoding apparatus supporting a scalable multichannel audio signal, and methods performed by the apparatuses, and more particularly, to an apparatus and method for compressing and decompressing a multichannel audio signal so as to provide 3-dimensional (3D) audio in a realistic broadcasting environment which provides excellent realism.

### BACKGROUND ART

A multichannel audio signal, such as a 5.1-channel signal, may be compressed and decompressed, that is encoded and (decoded to be efficiently transmitted through a is broadcasting network and the like or to be stored in an optical recording medium such as a digital Versatile disc (DVD) or a Blue-ray. The encoding and decoding scheme is based on a perceptual audio coding technology that uses a psychoacoustic model and time and frequency conversion. In addition, a channel coding technology using correlation between adjacent signals in a multichannel audio signal is further used

Recently to provide a multichannel audio service in a bandwidth limited environment such as mobile broadcasting, and an internet protocol television (IPTV), a spatial audio coding technology is being developed, which compresses a spatial cue included in a multichannel audio signal in a parameter form. The spatial audio coding technology downmixes a multichannel audio signal to a mono signal or a stero signal, and encodes a spatial parameter necessary for decoding the multichannel audio signal, by additional information. Moving picture experts group (MPEG) surround which is a standardized MPEG technology is a representative of the spatial audio coding technology.

To favorably realize realistic audio that provides realism in the realistic broadcasting environment such as 3DTV or an ultra high definition TV (UHDTV), a loud speaker having 10 channels or more may be necessary. For example, a 22.2-channel multichannel audio reproduction system may be used to realize the realistic audio.

Researches are under way as to quantity and an arrangement method of the loud speakers necessary in general home or theaters. So far, a 5.1-channel audio signal applied to an HDTV and a DVD is widely used. In addition, a DVD-HD and a Blue-ray suggested to substitute for the DVD may support up to a 7.1-channel audio signal. A specific company has suggested a system supporting up to a 10.2-channel signal. In addition, a wave field synthesis (WFS) system developed to provide a wide sound field in a large-scale audio reproduction environment such as a theater may use a loud speaker having 100 channels or more.

Most TVs and radio systems employ a 2-channel loud, speaker in consideration of an actual home audio reproduction environment. Due to recent spread of the HDTV and the DVD, homes with a reproduction environment supporting the 5.1-channel audio signal are gradually increasing. However, since it is almost impractical to spread a reproduction environment applying a loud speaker having 10 channels or more for a short time, the suggested encoding and reproduction technology for a multichannel audio signal needs to provide a function for maintaining compatibility with or converting into a 2-channel stereo system and a 5.1-channel system conventionally provided.

Furthermore, to maximize presence through audio in a wide-screen realistic image based video service such as a 3DTV a UHDTV, a 3D cinema, a digital cinema, and the like, a format gradually increasing a number of loud sneaker channels, such as WFS of 10.2 channels, 22.2 channels, 100 channels, or more, is necessary. Therefore, a method for efficiently compressing and transmitting audio content is required from audio encoding process.

### DISCLOSURE OF INVENTION

### Technical Goals

An aspect of the present invention provides a method for compressing and decompressing a multichannel audio signal to provide 3-dimensional (3D) audio in a realistic broadcasting environment that provides realism, such as a 3D television (3DTV) or an ultra high definition TV (UHDTV).

Another aspect of the present invention provides an apparatus and method of encoding and decoding scalable sound quality to provide adaptive sound quality corresponding to a transmission environment, performance of a terminal, and a taste of a listener.

Still another aspect of the present invention provides an apparatus and method for encoding and decoding a scalable channel to provide adaptive multichannel audio according to a transmission environment, a reproduction environment of a terminal, for example a speaker arrangement, and a taste of a listener.

Yet another aspect of the present invention provides an apparatus and method for processing arm audio object signal to provide interactivity to a listener or provide an independent 3D effect to a particular audio object signal.

### Technical Solutions

According to an aspect of the present invention, there is provided an encoding apparatus including a signal generation unit to generate a backward compatible multichannel audio signal using an audio object signal and a multichannel audio signal, a first encoding unit to generate a first bitstream by hierarchically encoding the backward compatible multichannel audio signal, a second encoding unit to generate a second bitstream by encoding the audio object signal, and a bitstream formatter to generate an output bitstream using the first bitstream and the second bitstream.

According to another aspect of the present invention, there is provided a decoding apparatus including a bitstream demultiplexing unit to extract, from an output bitstream, a first bitstream including an encoded backward compatible multichannel audio signal and a second bitstream including an encoded audio object signal, a first multiplexing unit to output the backward compatible multichannel audio signal by decoding the first bitstream, a second multiplexing unit to output the audio object signal by decoding the second bitstream, and a rendering unit to synthesize the backward compatible multichannel audio signal and the audio object signal being output.

According to yet another aspect of the present invention, there is provided an encoding method including generating a backward compatible multichannel audio signal using an audio object signal and a multichannel audio signal being input, generating a first bitstream by hierarchically encoding the backward compatible multichannel audio signal, generating a second bitstream by encoding the audio object signal, and generating an output bitstream using the first bitstream and the second bitstream.

According to still another aspect of the present invention, there is provided an output bitstream for a scalable multichannel audio signal, the output bitstream including a first bitstream encoded from a backward compatible multichannel audio signal and an audio object signal, a second bitstream encoded from the audio object signal, and additional information comprising at least one of first additional information for editing the audio object signal in the backward compatible multichannel audio signal, second additional information related to the backward compatible multichannel audio signal, and third additional information related to the audio object signal.

### Effects

According to an embodiment of the present invention, a multichannel audio signal may be compressed and decompressed, the multichannel audio signal for providing 3-dimensional (3D) audio in a realistic broadcasting environment that provides realism, such as a 3D television (3DTV) or an ultra high definition TV (UHDTV).

According to an embodiment of the present invention, encoding and decoding of scalable sound quality may be performed to provide adaptive sound quality corresponding to a transmission environment, performance of a terminal, and a taste of a listener.

According to an embodiment of the present invention, encoding and decoding a scalable channel may be performed to provide adaptive multichannel audio according to a transmission environment, a reproduction environment of a terminal, for example a speaker arrangement, and a taste of a listener.

According to an embodiment of the present invention, an audio object signal for providing interactivity to a listener or providing an independent 3D effect to a particular audio object signal may be processed.

### BRIEF DESCRIPTION OF DRAWINGS

FIG. 1 is a diagram illustrating an encoding apparatus and a decoding apparatus according to an embodiment of the present invention.

FIG. 2 is a diagram illustrating a detailed structure of the encoding apparatus according to the embodiment of the present invention.

FIG. 3 is a diagram illustrating a detailed structure of the decoding apparatus according to the embodiment of the present invention.

FIG. 4 is a diagram illustrating a scalable channel encoding method according to an embodiment of the present invention.

FIG. 5 is a diagram illustrating a scalable channel decoding method according to an embodiment of the present invention.

FIG. 6 is a diagram illustrating a scalable quality encoding method according to an embodiment of the present invention.

FIG. 7 is a diagram illustrating a scalable quality decoding method according to an embodiment of the present invention.

FIG. 8 is a diagram illustrating components of an output bitstream according to an embodiment of the present invention.

FIG. 9 is a diagram illustrating modularized bitstreams according to an embodiment of the present invention.

FIG. 10 is a diagram illustrating a basic structure of a modularized bitstream according to an embodiment of the present invention.

FIG. 11 is a diagram illustrating types of a payload of a processing unit (PU) in a basic structure of a bitstream, according to an embodiment of the present invention.

FIG. 12 is as diagram illustrating process of decompressing an audio signal according to an audio reproduction environment, according to an embodiment of the present invention.

FIG. 13 is a diagram illustrating an encoding method according to an embodiment of present invention.

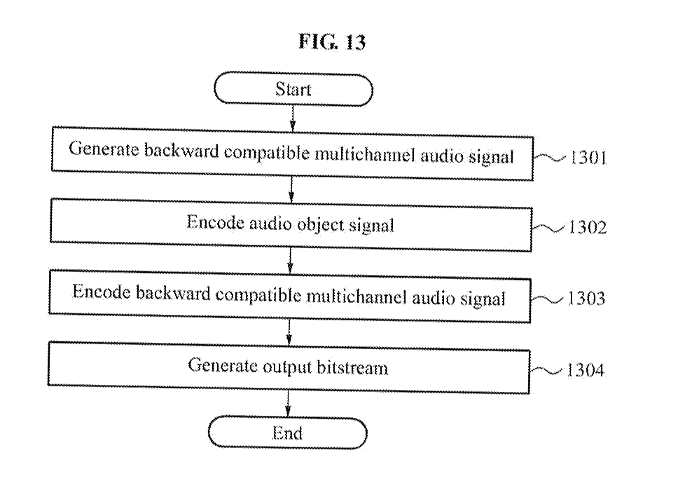

FIG. 14 is a diagram illustrating a decoding method according to an embodiment of the present invention.

### BEST MODE FOR CARRYING OUT THE INVENTION

Reference will now be made in detail to embodiments of the present invention, examples of which are illustrated in the accompanying drawings, wherein like reference numerals refer to the like elements throughout. The embodiments are described below in order to explain the present invention by referring to the figures.

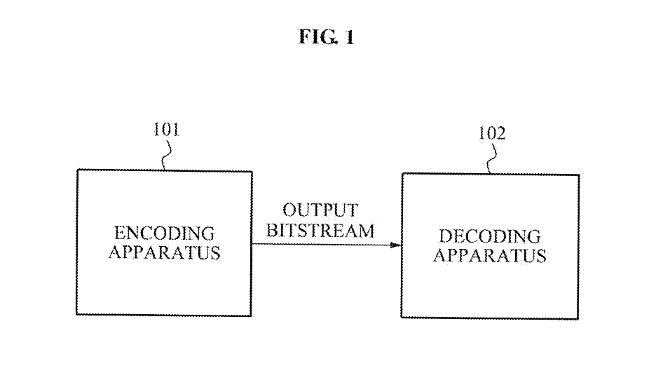

FIG. 1 is a diagram illustrating an encoding apparatus 101 and a decoding apparatus 102 according to an embodiment of the present invention.

Referring to FIG. 1, the encoding apparatus 101 may be input with an audio object signal and a multichannel audio signal. The encoding apparatus 101 may generate an output bitstream by encoding the audio object signal and a backward compatible multichannel audio signal in which the audio object signal and the multichannel audio signal are synthesized. Here, the encoding apparatus 101 may add additional information for the audio object signal and additional information for the backward compatible multichannel audio signal. In addition, the encoding apparatus 101 may add, to the output bitstream, additional information for removing or extracting the audio object signal from the backward compatible multichannel audio signal.

Here, the encoding apparatus 101 may apply scalable channel encoding, and sealable quality encoding during the encoding process. The scalable channel encoding and the scalable quality encoding will be described in detail.

The output bitstream may be transmitted to the decoding apparatus 102 in real time, or transmitted to the decoding apparatus 102 in advance and stored in a storage medium such as a buffer or a memory of the decoding apparatus 102. Also, the output bitstream may be stored in an optical recording medium, for example, a compact disc-read only memory (CD-ROM), a CD-rewritable (RW), digital versatile disc-recordable (DVD-R), and DVD-RW, and distributed.

The encoding apparatus 101 may extract the audio object signal and the backward compatible multichannel audio signal from the output bitstream being input. In addition. the encoding apparatus 101 may output the extracted multichannel audio signal directly, or output an output signal rendered in combination with the audio object signal. Here, the rendering may be performed in consideration of an audio reproduction environment related to the decoding apparatus 102. The encoding apparatus 101 refers to a reproduction terminal connectable with a wired or wireless network. In addition, the encoding apparatus 101 may reproduce the audio signal in various forms through connection with at least one speaker.

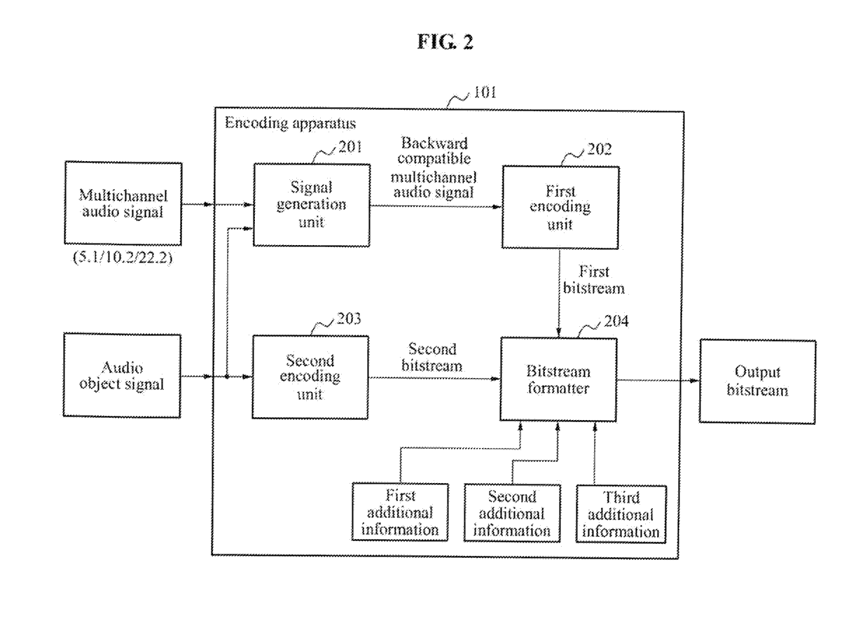

FIG. 2 is a diagram illustrating a detailed structure of the encoding apparatus 101 according to an embodiment of the present invention.

Referring to FIG. 2, the encoding apparatus 101 may include a signal generation unit 201, a first encoding unit 202, a second encoding unit 203, and a bitstream formatter 204.

The signal generation unit 201 may mix an audio object signal and an input multichannel audio signal, thereby generating a backward compatible multichannel audio signal, Additionally, the signal generation unit 201 may predict first additional information necessary for removing or extracting the audio object signal from the backward compatible multichannel audio signal. When the audio object signal is already included in the multichannel audio signal input to the encoding apparatus 101, the signal generation unit 201 may output the multichannel audio signal as the backward compatible multichannel audio signal, In this case, the signal generation unit 201 may predict only the first additional information for removing or extracting the audio object signal from the backward compatible multichannel audio signal.

Here, the predicted first additional information may include a spatial parameter per grid of time or frequency, and a residual signal. Also, for prediction of the first additional information third additional information related to the audio object signal may be further used. The third additional intonation may include rendering information.

The audio object signal is related to a sound source of an audio signal. The audio object signal may include either an audio object signal corresponding to a time domain or an audio object signal convened into a frequency domain during encoding by the second encoding unit 203. The multichannel audio object signal may refer to an audio signal including a plurality of channels, for example, 2 channels, 5.1 channels, 7.1 channels, 10.2 channels, 22.2 channels, and the like.

The first encoding unit 202 may generate a first bitstream by hierarchically encoding the backward compatible multichannel audio signal. The first bitstream may be expressed as a scalable channel bitstream. The first encoding unit 202 may predict second additional information for supporting a channel format not expressed during the hierarchical encoding of the backward compatible multichannel audio signal. The second additional information may include a downmix matrix, a downmix parameter, an upmix matrix, and an upmix parameter.

The second encoding unit 203 may generate a second bitstream by encoding the audio object signal.

The bitstream formatter 204 may generate an output bitstream by multiplexing the first bitstream of the first encoding unit 202 and the second bitstream of the second encoding unit 203. In addition, the bitstream formatter 204 may add, to the output bitstream, the first additional information for editing the audio object signal in the backward compatible multichannel audio signal, the second additional information related to the backward compatible multichannel audio signal, and the third additional information related to the audio object signal.

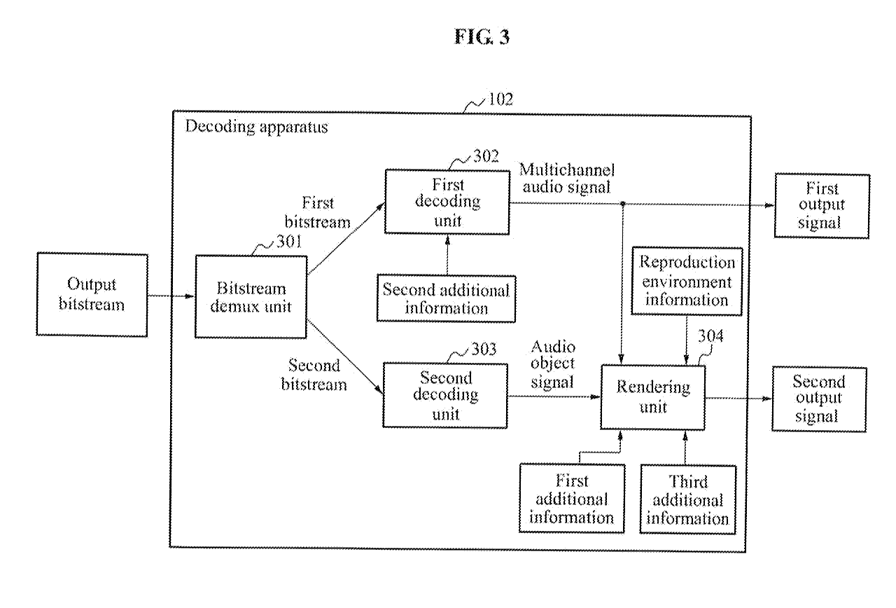

FIG. 3 is a diagram illustrating a detailed structure of the decoding apparatus 102 according to the embodiment of the present invention.

Referring to FIG. 3, the decoding apparatus 102 may include a bitstream demultiplexing (DEMUX) unit 301, a first decoding unit 302, a second decoding unit 303, and a rendering unit 304.

When the output bitstream has a compatible structure, the decoding apparatus 102 may decode a multichannel audio signal being generally known, such as a stereo signal and a 5.1 channel signal, through a legacy multichannel decoding unit (not shown).

The bitstream DEMUX unit 301 may extract the first bitstream including the decoded backward compatible multichannel audio signal and the second bitstream including the decoded audio object signal, from the output bitstream.

In detail, the bitstream DEMUX unit 301 may separate the output bitstream into a plurality of bitstream blocks according to decoding blocks. Here, the bitstream blocks being separated may include a scalable channel bitstream, an object bitstream, a scalable quality bitstream, additional information for the foregoing bitstreams, and header information related to the output bitstream. The header information may include additional information necessary for initializing the entire decoding apparatus 102 and initializing the components of the decoding apparatus 102.

The first decoding unit 302 may output a backward compatible multichannel audio signal by decoding the first bitstream. The first decoding unit 302 may extract the backward compatible multichannel audio signal corresponding to an audio reproduction environment of the decoding apparatus 102 using additional information related to the backward compatible multichannel audio signal. Here, the additional information related to the backward compatible multichannel audio signal may refer to additional information for the scalable channel. The backward compatible multichannel audio signal being extracted may be output directly as a first output signal or transmitted to the rendering unit 304.

The audio reproduction environment of the decoding apparatus 102 may refer to a reproduction environment for a multichannel audio signal related to the decoding apparatus 102. In detail, the audio reproduction environment may be determined by a number and positions of speakers related to the decoding apparatus 102.

The second decoding unit 303 ma output the audio object signal by demultiplexing the second bitstream.

The rendering unit 304 may synthesize the backward compatible multichannel audio signal output from the first decoding unit 302 and a second audio object signal output from the second decoding unit 303. Specifically, the rendering unit 304 may synthesize the backward compatible multichannel audio signal and the second audio object signal m consideration of the audio reproduction environment of the decoding apparatus 102.

When the audio object signal is already included in the backward compatible multichannel audio signal, the rendering unit 304 may remove the audio object signal from the backward compatible multichannel audio signal using additional information for removing the audio object signal. Therefore, the rendering unit 304 may render the audio object signal transmitted from the second decoding unit 303 with respect to the backward compatible multichannel audio signal, thereby outputting a second output signal.

When the audio object signal is not included in the backward compatible multichannel audio signal, the rendering unit 304 may not remove the audio object signal from the backward compatible multichannel audio signal. The rendering unit 304 may render the audio object signal with respect to the backward compatible multichannel audio signal, based on a rendering position of the audio object signal. Here, the rendering position of the audio object signal may be included in the additional information related to the audio object signal.

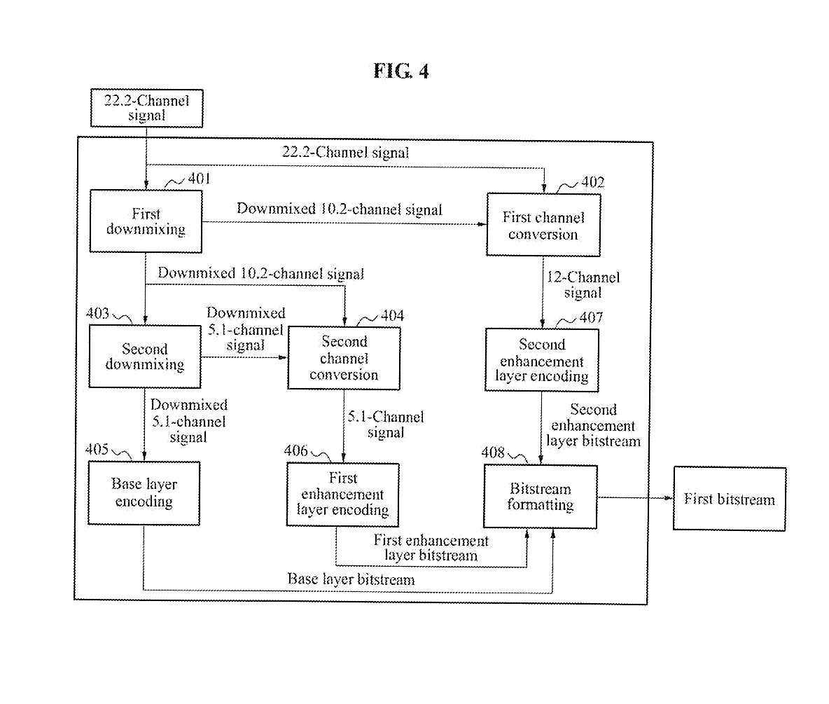

FIG. 4 is a diagram illustrating a scalable channel encoding method according to an embodiment of the present invention.

The scalable channel encoding method may be applied to the first encoding unit 202 of FIG. 2. Specifically, the first encoding unit 202 may generate the first bitstream which is a scalable channel bitstream, by hierarchically encoding the backward compatible multichannel audio signal according to the scalable channel encoding method.

FIG. 4 shows the process of encoding the multichannel audio signal according to the scalable channel encoding method when the multichannel audio signal is a 22.2-channel signal. In detail, FIG. 4 shows the 22.2-channel signal being hierarchically encoded to at 5.1-channel signal, a 10.2-channel signal, and a 22.2-channel signal.

FIG. 4 is a block diagram of a scalable channel decoder 204, showing the process of decoding 5.1-channel, 10.2-channel, and 22.2-channel hierarchical encoding bitstreams passed through the encoding of FIG. 4.

In FIG. 4, the 22.2-channel signal being input is downmixed to the 10.2-channel signal through first downmixing 401. The 22.2-channel signal is converted into a 12-channel signal through first channel conversion 402 to which the downmixed 10.2-channel signal is input.

The downmixed 10.2-channel signal may be downmixed to the 5.1-channel signal through second downmixing 403. The downmixed 5.1-channel signal output through the second downmixing 103 may be encoded according to base hierarchical encoding 405. The result of encoding according to the base hierarchical encoding 403 may refer to a base layer bitstream.

The downmixed 10.2-channel signal output by the first downmixing, 401 may be converted into the 5.1-channel signal through second channel conversion 404 to which the downmixed 5.1-channel signal output through the second downmixing 403 is input. The converted 5.1-channel signal may be encoded through first enhancement layer encoding 406. The result of encoding through the first enhancement layer encoding 406 may refer to a first enhancement layer bitstream.

The 12-channel signal output by the first channel conversion 402 may be encoded through second enhancement layer encoding 407. The result of encoding through the second enhancement layer encoding 407 may refer to a second enhancement layer bitstream.

Accordingly, the base layer bitstream, the first enhancement layer bitstream, and the second enhancement layer bitstream may be multiplexed through bitstream formatting 408, thereby generating the first bitstream. Information on downmixing and channel conversion, generated during the scalable channel encoding, may be provided as scalable channel additional information for decoding of the decoding apparatus 102.

Thus, the scalable channel encoding method may refer to encoding of the multichannel audio signal of the base layer and the multichannel audio signal of the enhancement layer, induced through at least one time of downmixing and channel conversion. The number of performances of downmixing and channel conversion may be varied according to the multichannel audio signal being input.

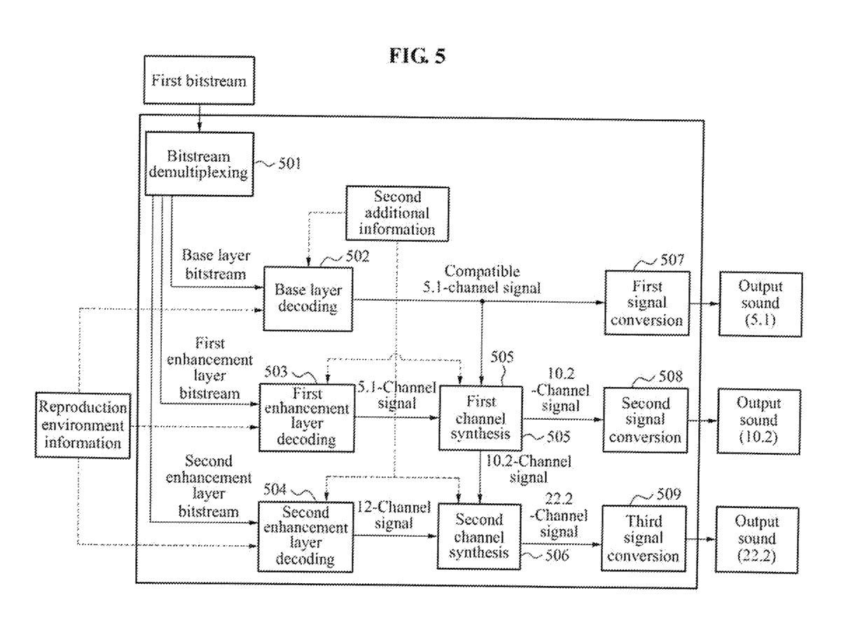

FIG. 5 is a diagram illustrating a scalable channel decoding method according to an embodiment of the present invention.

FIG. 5 shows the first bitstream being decoded by the scalable channel decoding method in the decoding apparatus 102. The first bitstream may be demultiplexed to the base layer bitstream, the first enhancement layer bitstream, and the second enhancement layer bitstream through bitstream demultiplexing 501.

The base layer bitstream may be decoded through base layer decoding 502 and accordingly a compatible 5.1-channel signal ma be output. Therefore, the compatible 5.1-channel signal may be output as 5.1-channel output sound through first signal conversion 507. When the compatible 5.1-channel signal is as frequency domain signal, the compatible 5.1-channel signal may be converted from a frequency domain to a time domain through the first signal conversion 507.

The first enhancement layer bitstream may be output as the 5.1-channel signal through first enhancement layer decoding 503. Therefore, the compatible 5.1-channel signal output through the base layer decoding 502 and the 5.1-channel signal output through the first enhancement layer decoding 503 may be synthesized to a 10.2-channel signal by first channel synthesis 505. Here, the first channel synthesis 505 may be processed according to additional information included in the scalable channel additional information. In addition, the synthesized 10.2-channel signal ma be output as 10.2-channel output sound through second signal conversion 508.

The second enhancement layer bitstream may be output as the 12-channel signal through second enhancement layer decoding 504. Therefore, the compatible 10.1-channel signal output through the first channel synthesis 505 and the 12-channel signal output through the second enhancement layer decoding 504 may be synthesized to a 22.2-channel signal by second channel synthesis 506. Here the second channel synthesis 506 may be processed according to additional information included in the scalable channel additional information. In addition, the synthesized 22.2-channel signal may be output as 22.2-channel output sound through third signal conversion 509,

All processes of FIG. 5 may be performed by the first decoding unit 502 of the decoding apparatus 102. In addition, all the operations of FIG. 5 may be controlled based on reproduction environment information transmitted from the encoding apparatus 101 or provided by the decoding apparatus 102. In addition, in case of other channel structures. for example the 7.1-channel structure, besides the hierarchical channel structures such as the 5.1-channel structure, the 10.1-channel structure, and the 22.2-channel structure shown in FIG. 5, the first channel synthesis 505 and the second channel synthesis 506 may include downmixing and upmixing according to the channel structure. Information necessary for the downmixing or upmixing may be transmitted as additional information from the encoding apparatus 101 or estimated by the decoding apparatus 102.

Thus, the scalable channel decoding method may refer to decoding of the multichannel audio signal of the base layer and the multichannel audio signal of the enhancement layer through at least one time of upmixing and channel synthesis.

FIG, 6 is a diagram illustrating a scalable quality encoding method according to an embodiment of the present invention.

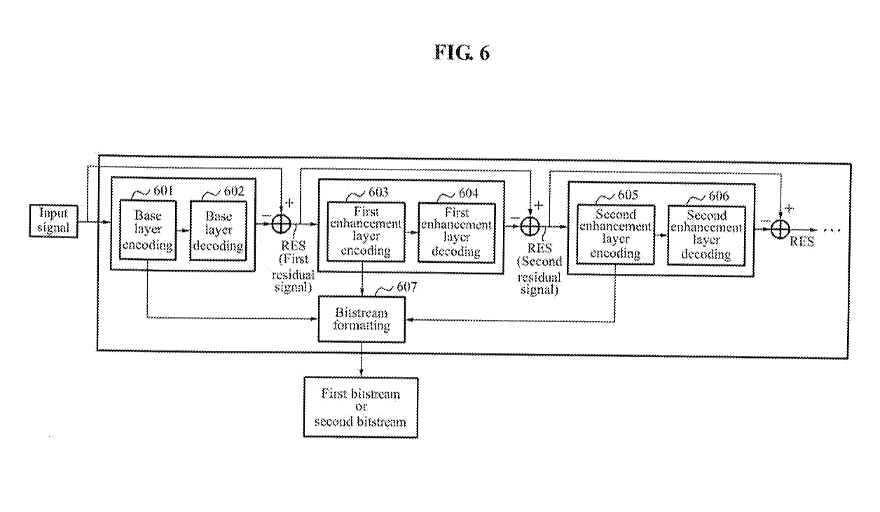

The scalable quality encoding method of FIG. 6 may be applied to the first encoding unit 202 and the second encoding unit 203. An input signal of FIG. 6 may refer to an audio object signal or a backward compatible multichannel audio signal.

The input signal may be processed by base layer encoding 601 and base layer decoding 602. A base layer bitstream may he generated through the base layer encoding 601. In addition, a first residual signal denoting a difference between the input signal and a synthesized signal output through the base layer decoding 602 may be generated.

The first residual signal may be processed by first enhancement layer encoding 603 and first enhancement layer decoding 604. A first enhancement layer bitstream may he generated through the first enhancement layer encoding 603. In addition, a in second residual signal denoting a difference between the first residual signal and a synthesized signal output through the first enhancement layer decoding 604 may be generated.

The second residual signal may be processed by second enhancement layer encoding 605 and second enhancement layer decoding 606. A second enhancement layer bitstream may be getter MA through the second enhancement layer encoding 605.

In addition a third residual signal denoting a difference between the second residual signal and a synthesized signal output through the second enhancement law decoding 606 may be generated.

The foregoing process ma be repeated until an output signal meeting a predetermined sound quality is derived. The base enhancement layer bitstream output through the base layer encoding 601 the first enhancement layer bitstream output through the first enhancement layer encoding 603, and the second enhancement layer bitstream output through the second enhancement layer encoding 605 may be multiplexed through bitstream formatting 607 and output as the first bitstream or the second bitstream.

Therefore, the method of FIG. 6 may he performed to provide scalability with respect to the sound quality. The scalable quality encoding method of FIG. 6 may refer to base layer encoding with respect to the input backward compatible multichannel audio signal or the audio object signal and at least one time of enhancement layer encoding, which are repeatedly performed.

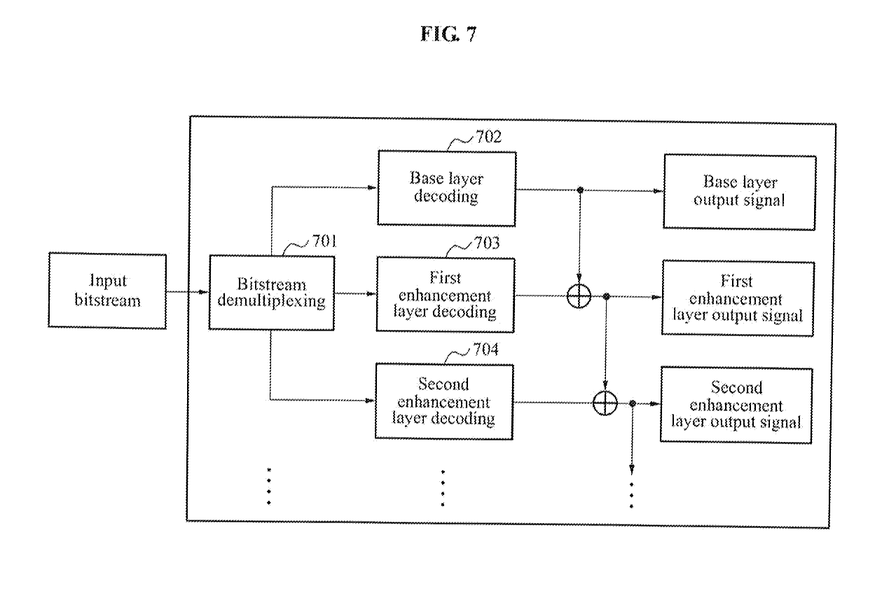

FIG. 7 is a diagram illustrating a scalable quality decoding method according to an embodiment of the present invention.

In FIG. 7, an input bitstream may refer to an encoding result of the audio object signal or the backward compatible multichannel audio signal encoded according to the to scalable quality encoding. For example, the input bitstream may be separated into bitstreams of respective layers through demultiplexing 701. For example, the input bitstream may be separated into one base layer bitstream and a plurality of enhancement layer bitstreams through the bitstream &multiplexing 701. The base layer bitstream may be output as a base layer output signal through base layer decoding 702.

The first enhancement layer bitstream corresponding to the first enhancement laser may be decoded through first enhancement layer decoding 703. An output signal decoded through the first enhancement layer decoding 703 may be summed up with the base layer output signal and output as a first enhancement layer output signal.

The second enhancement layer bitstream corresponding to the second enhancement layer may be decoded through second enhancement layer decoding 704. An output signal decoded through the second enhancement layer decoding 704 may be summed up with the first enhancement layer output signal and output as a second enhancement layer output signal. The process of FIG. 7 may be repeated according to the input bitstream.

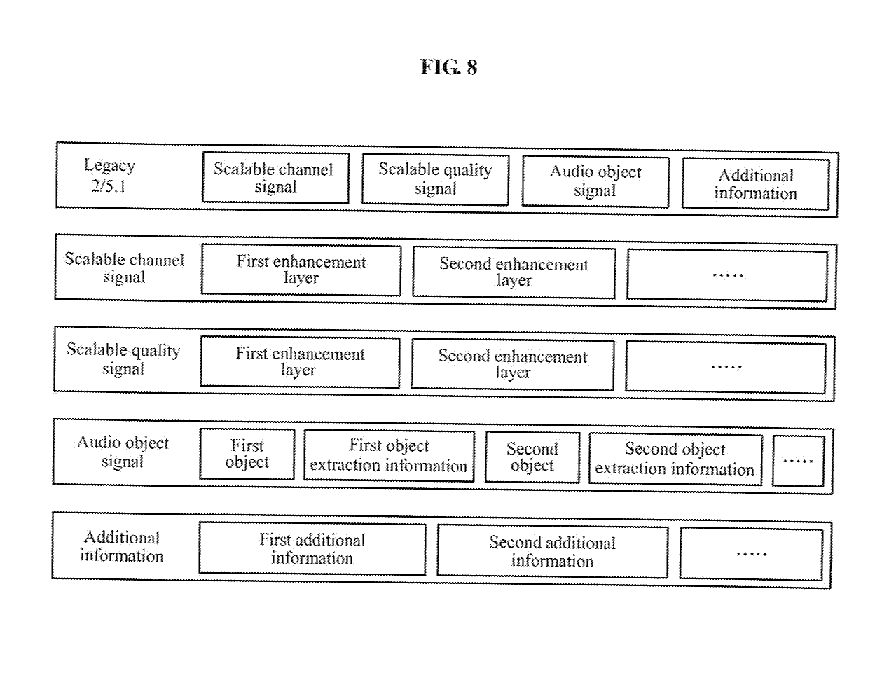

FIG. 8 is a diagram illustrating components of an output bitstream according to an embodiment of the present invention.

As shown in FIG. 2, bitstreams resulting from encoding by the first encoding unit 202 and the second encoding unit 203 of the encoding apparatus 101 may be multiplexed through the bitstream formatter 204. As a result, output bitstreams are generated. FIG. 8 shows the output bitstream resulting from multiplexing bitstreams while maintaining compatibility with a decoding apparatus supporting the conventional stereo audio signal or the 5.1-channel audio signal.

To maintain compatibility, the output bitstream may include a compatible bitstream structure (legacy 2/5.1) related to a stereo channel that is, 2-channel signal, or the 5.1-channel signal, which is a moving picture experts group (MPEG)-2 audio backward compatibility bitstream structure. The backward compatability bitstream structure may include a sealable channel signal, a scalable quality signal, an audio object signal, and additional information related to the stereo channel signal, that is, the 2-channel signal, or the 5.1-channel signal.

In the output bitstream, the scalable channel signal, the scalable quality signal the audio object signal, and the additional information may be included in an additional information region such as an ancillary data region of the MPEG-2 audio backward compatibility bitstream structure. Here, the scalable quality signal refers to an audio signal having a sound quality desired by a user, based on the plurality of layers.

A container of the scalable channel signal may include bitstreams according to layers, in which channels are increased or enhanced, and additional information. A container of the scalable quality signal may include bitstreams according to lasers, in which sound quality is increased, and additional information. In addition, container of the audio object signal may include the audio object signal, additional information related to the audio object signal, and extraction additional information of the audio object signal. A container of the additional information may include additional information inserted in the containers of the scalable channel signal, the sealable quality signal, and the audio object signal. Furthermore, the container of the additional information may include header additional information meta data, and the like necessary for initializing the components of the encoding apparatus and the decoding apparatus.

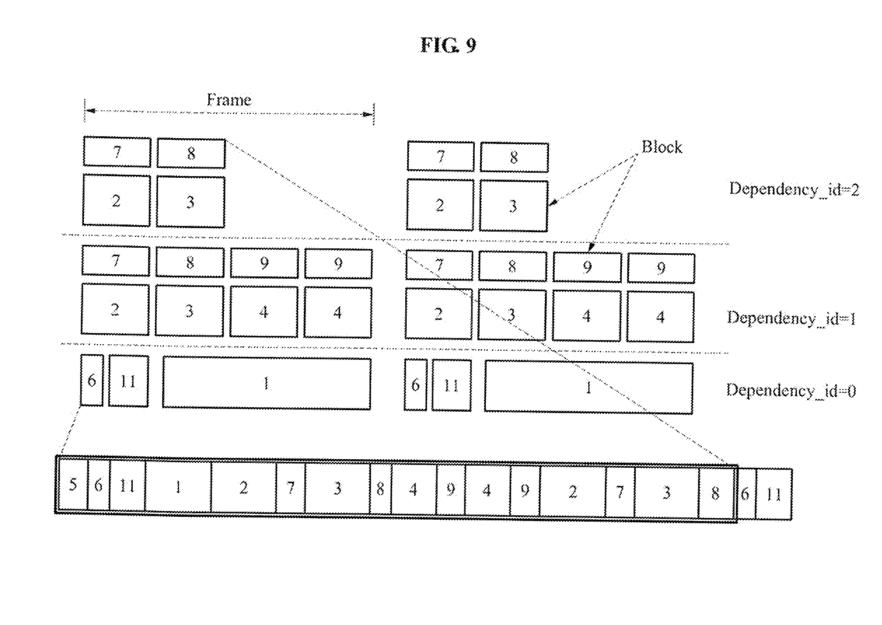

FIG. 9 is a diagram illustrating modularized bitstreams according to an embodiment of the present invention.

FIG. 9 shows a structure such as in a network abstraction layer (NAL) unit used in H.264/AVC. which selects an encoded output bitstream according to transmission environment. FIG. 9 also shows a result of modularizing bitstreams output from respective components of an encoding apparatus, so that a decoding apparatus easily select and process necessary information from the output bitstreams.

FIG. 9 illustrates a structure of processing units (PU) included in a frame shown in F1G. 10 and an order of transmitting the PUs in a case in which an output bitstream includes a core layer, that is, a base multichannel signal, two channel enhancement layers, one quality enhancement layer, and two object signal layers. In FIG. 9, dependency_id denotes necessity of information on a previous layer for decoding the PU.

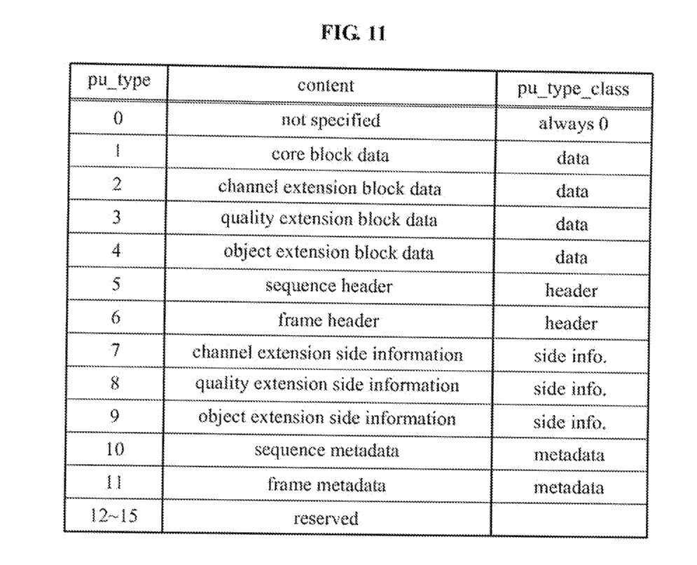

In FIG. 9, numbers allocated to blocks refer to a pu_type of FIG. 11. First, a sequence header including information necessary for initializing the decoding apparatus is transmitted. Next, a frame header and frame metadata are arranged. After that, bitstream output from respective encoding blocks, that is, the first encoding unit and the second encoding unit, are arranged, being separated into core block data and channel/quality/object enhancement data. In addition, data per the respective encoding blocks, that is, the first encoding unit and the second encoding unit, or information additionally necessary for the bitstream may be arranged.

Thus, the decoding apparatus may select the transmitted PUs according to an audio reproduction environment or user tastes and generate an audio signal to be output.

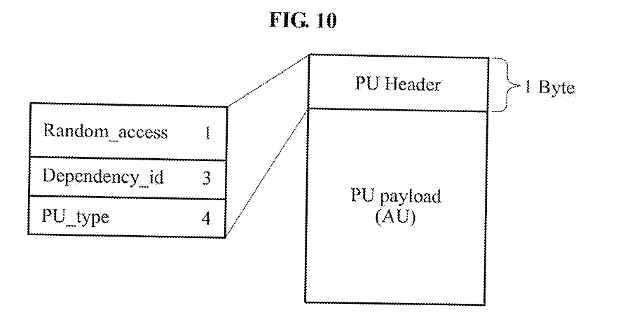

FIG. 10 is a diagram illustrating a h sac structure of as modularized bitstream according to an embodiment of the present invention.

FIG. 10 showing the basic structure of a result of modularizing the bitstream shown in FIG, 8. The basic structure may be a base unit constituting the output bitstream. The base unit may be defined as a PU. 1 byte may be allocated to a header of the PU to include information of 1 bit of random_access, 3 bits of dependency_id, and 4 bits of pu_type, random_access may be a flag informing whether decoding without information on a previous layer is possible in the PU, dependency_id may inform that information on the previous layer is necessary for decoding the PU. For example, when dependency_id is 1, this means that one previous layer, that is the base layer, is necessary, pu_type may denote a type of a bitstream input to a payload of the PU. pu_type will be described in detail with reference to FIG. 11.

FIG. 11 is a diagram illustrating types of a payload of a PU in a basic structure of a bitstream, according to an embodiment of the present invention.

pu_type denotes a type of as bitstream input to the payload of the PU. In the payload of the PU defined by the pu_type, a sequence header denotes a header of an output bitstream input to an encoding apparatus. A frame header denotes a header of each frame. The payload of the PU may be an access unit (AU) which is an encoded bitstream extracted from components of the encoding apparatus.

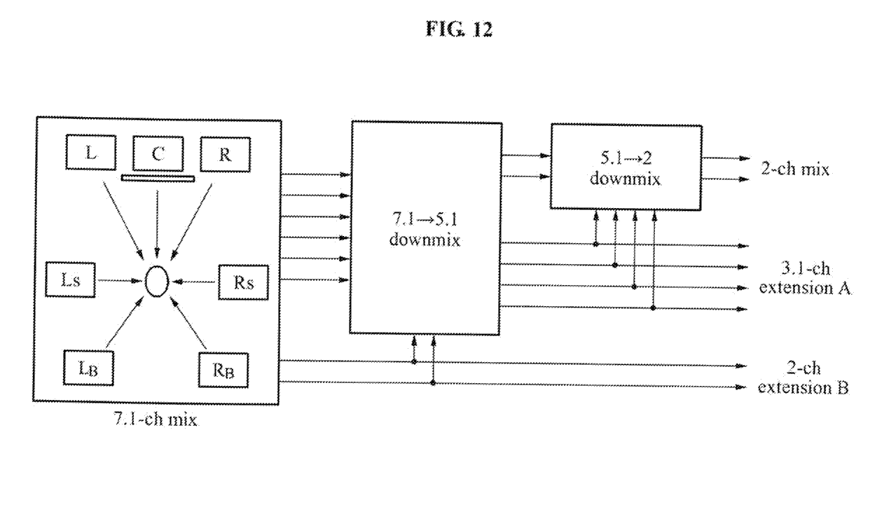

FIG. 12 is a diagram illustrating process of decompressing an audio signal according to an audio reproduction environment, according to an embodiment of the present invention.

FIG. 12 shows the process of encoding a 7.1-channel audio signal from an encoded bitstream by distributing the 7.1-channel audio signal according to an audio reproduction environment, and restoring the encoded 7.1-channel audio signal. Referring to FIG. 12, the 7.1-channel audio signal may be encoded by being distributed into three components, that is, 2-channel stereo, 3.1-channel extension A, and 2-channel extension B. A result of the distributed encoding may be multiplexed and transmitted to as one entire bitstream.

Therefore, in a terminal capable of reproducing a stereo signal, only a bitstream related to the 2-channel stereo may be extracted from the entire bitstream and reproduced. In addition, in a terminal capable of reproducing the 5.1-channel signal, the 5.1-channel signal may be reproduced using a 2-channel stereo bitstream and a 3.1-channel extension A bitstream. In a terminal capable of reproducing a 7.1-channel signal, all bitstreams included in the entire bitstream may be used to reproduce the 7.1-channel signal.

That is, according to the embodiments of the present invention, even in the audio reproduction environment for the stereo signal and the 5.1-channel signal, a necessary bitstream out of the entire bitstream may be used without dedicated conversion to restore the audio signal corresponding to the reproduction environment of the terminal.

FIG, 13 is a diagram illustrating an encoding method according to an embodiment of the present invention.

In operation 1301, the encoding apparatus 101 may generate a backward compatible multichannel audio signal by synthesizing an audio object signal being input and a multichannel audio signal.

In operation 1302, the encoding apparatus 101 may generate a bitstream related to the audio object signal, by encoding the audio object signal being input. For example, the encoding apparatus 101 may hierarchically encode the audio object signal according to a scalable quality encoding method.

In operation 1303, the encoding apparatus 101 may generate a bitstream related to the backward compatible multichannel audio signal, by encoding the backward compatible multichannel audio signal. For example, the encoding apparatus 101 may hierarchically encode the backward compatible multichannel audio signal according to the scalable quality encoding method or a sealable channel encoding method.

In operation 1304, the encoding apparatus 101 may finally generate an output bitstream by multiplexing the generated bitstreams. The encoding apparatus 101 may include, in the output bitstream, additional information related to the audio object signal and the backward compatible multichannel audio signal.

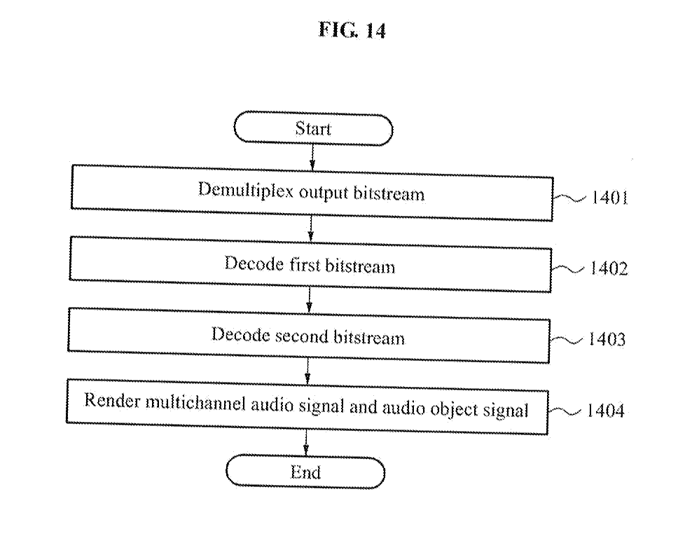

FIG. 14 is a diagram illustrating a decoding method according to an embodiment of the present invention.

In operation 1401, the decoding apparatus 102 may demultiplex the output bitstream transmitted from the encoding apparatus 101. Therefore, a first bitstream encoded from the backward compatible multichannel audio signal and a second bitstream encoded from the audio object signal may be divided from the output bitstream.

In operation 1402, the decoding apparatus 102 may decode the first bitstream, thereby outputting the backward compatible multichannel audio signal. For example. the decoding apparatus 102 may extract the backward compatible multichannel audio signal from the first bitstream according to a scalable quality decoding method or a scalable channel decoding method. The backward compatible multichannel audio signal being output may be directly output to an outside.

In operation 1403, the decoding apparatus 102 may decode the second bitstream, thereby outputting the audio object signal. For example, the decoding apparatus 102 may output the audio object signal from the second bitstream according to the scalable quality decoding method.

In operation 1404, the decoding apparatus 102 may synthesize the backward compatible multichannel audio signal and the audio object signal, thereby deriving a rendering result. In detail, the decoding apparatus 102 may combine the audio object signal in consideration of positions or arrangement of loudspeakers corresponding to the audio reproduction environment. Furthermore, the decoding apparatus 102 may derive a multichannel audio signal to be finally output from the backward compatible multichannel audio signal, through repeated channel conversion and synthesis in consideration of the positions or arrangement of the loud speakers.

The above-described embodiments may be recorded, stored, or fixed in one or more non-transitory computer-readable media that includes program instructions to be implemented by a computer to cause a processor to execute or perform the program instructions. The media may also include, alone or in combination with the program instructions, data files, data structures, and the like. The program instructions recorded on the media m. v be those specially designed and constructed, or they may be of the kind well-known and available to those having skill in the computer software arts.

A number of examples have been described above. Nevertheless, it will be understood that various modifications may be made. For example, suitable results may be achieved d the described techniques are performed in a different order and/or if components in a described system, architecture, device, or circuit are combined in a different manner and/or replaced or supplemented by other components or their equivalents.

Accordingly, other implementations are within the scope of the following claims.

1. An encoding apparatus comprising:
as signal generation unit to generate a backward compatible multichannel audio signal using an audio object signal and a multichannel audio signal;
a first encoding unit to generate as first bitstream by hierarchically encoding the backward compatible multichannel audio signal;
a second encoding, unit to generate a second bitstream by encoding the audio object signal; and
a bitstream formatter to generate an output bitstream using the first bitstream and the second bitstream.

2. The encoding apparatus of claim 1, wherein the bitstream formatter comprises at least one of first additional information for editing the audio object signal in the backward compatible multichannel audio signal, second additional information related to the backward compatible multichannel audio signal, and third additional information related to the audio object signal.

3. The encoding apparatus of claim 1, wherein the first encoding unit generates the first bitstream by hierarchically encoding the backward compatible multichannel audio signal according to a scalable channel encoding method.

4. The encoding apparatus of claim 3, wherein the scalable channel encoding method comprises encoding of the multichannel audio signal of a base layer and the multichannel audio signal of an enhancement layer, induced through at least one time of downmixing and channel conversion.

5. The encoding apparatus of claim 1, wherein
the first encoding unit generates the first bitstream by hierarchically encoding the backward compatible multichannel audio signal according to a sealable quality encoding method, or
the second encoding unit generates the second bitstream by hierarchically encoding the audio object signal according to the scalable quality encoding method.

6. The encoding apparatus of claim 5, wherein the scalable quality encoding method repeatedly performs base layer encoding and at least one time of enhancement layer encoding with respect to the backward compatible multichannel audio signal or the audio object signal being input.

7. A decoding apparatus comprising:
is a bitstream demultiplexing unit to extract, from an output bitstream, a first bitstream including an encoded backward compatible multichannel audio signal and a second bitstream including an encoded audio object signal;
a first multiplexing unit to output the backward compatible multichannel audio signal by decoding the first bitstream;
a second multiplexing unit to output the audio object signal by decoding the second bitstream; and
a rendering unit to synthesize the backward compatible multichannel audio signal and the audio object signal being output.

8. the decoding apparatus of claim 7, wherein the demultiplexing unit comprises at least one of first additional information for editing the audio object signal in the backward compatible multichannel audio signal, second additional information related to the backward compatible multichannel audio signal, and third additional information related to the audio object signal.

9. The decoding apparatus of claim 7, wherein the first decoding unit generates the first bitstream by hierarchically decoding the backward compatible multichannel audio signal according to a scalable channel decoding method.

10. The decoding apparatus of claim 7, wherein the scalable channel decoding method comprises decoding of the multichannel audio signal of as base layer and the multichannel audio signal of an enhancement layer, through at least one time of upmixing and channel conversion.

11. The decoding apparatus of claim 7, wherein
the first decoding unit generates the first bitstream by hierarchically decoding the backward compatible multichannel audio signal according to a scalable quality decoding method, or
the second decoding unit generates the second bitstream by hierarchically decoding the audio object signal according to the scalable quality decoding method.

12. The decoding apparatus of claim 11, wherein the scalable quality decoding method repeatedly performs base layer decoding and at least one time of enhancement layer decoding with respect to the backward compatible multichannel audio signal or the audio object signal being input.

13. The decoding apparatus of claim 7, wherein the first decoding unit extracts the backward compatible multichannel audio signal corresponding to an audio reproduction environment of the decoding apparatus using the second additional information related to the backward compatible multichannel audio signal.

14. The decoding apparatus of claim 7, wherein the rendering unit synthesizes the backward compatible multichannel audio signal and the audio object signal in consideration of an audio reproduction environment of the decoding apparatus.

15. An encoding method comprising:
generating a backward compatible multichannel audio signal using an audio object signal and a multichannel audio signal being input;
generating a first bitstream by hierarchically encoding the backward compatible multichannel audio signal;
generating a second bitstream by encoding the audio object signal; and
generating an output bitstream using the first bitstream and the second bitstream.

16. The encoding method of claim 15, wherein the generating of the first bitstream comprises generating the first bitstream by hierarchically encoding the backward compatible multichannel audio signal according to a scalable channel encoding method.

17. The encoding method of claim 15, wherein the scalable channel encoding method comprises encoding of the multichannel audio signal of a base layer and the multichannel audio signal of an enhancement layer, induced through at least one time of downmixing and channel conversion.

18. The encoding method of claim 15, wherein the generating of the first bitstream comprises:
generating, the first bitstream by hierarchically encoding the backward compatible multichannel audio signal according to a scalable quality encoding method, or
generating the second bitstream by hierarchically encoding the audio object signal according to the scalable quality encoding method.

19. A decoding method comprising:
extracting, from an output bitstream, a first bitstream including an encoded backward compatible multichannel audio signal and a second bitstream including an encoded audio object signal;
outputting the backward compatible multichannel audio signal by decoding the first bitstream:
outputting the audio object signal by decoding the second bitstream; and
synthesizing the backward compatible multichannel audio signal and the audio object signal being output.

20. An output bitstream for a scalable multichannel audio signal, the output bitstream comprises:
a first bitstream encoded from a backward compatible multichannel audio signal and an audio object signal;
a second bitstream encoded from the audio object signal; and
additional information comprising at least one of first additional information for editing the audio object signal in the backward compatible multichannel audio signal, second additional information related to the backward compatible multichannel audio signal, and third additional information related to the audio object signal.
